(19) United States
(12) Patent Application Publication
(10) Pub. No.: US 2002/0048684 A1
(43) Pub. Date: Apr. 25, 2002

(54) Nickel-free white copper alloy material

(75) Inventors: Yasuhiko Sugimoto, Nakaniikawa-gun (JP); Norio Kikukawa, Namerikawa-shi (JP); Yasuharu Yoshimura, Kurobe-shi (JP); Hironobu Wakasa, Kurobe-shi (JP); Kazuhiko Kita, Sendai-shi (JP)

Correspondence Address: FINNEGAN, HENDERSON, FARABOW, GARRETT &, DUNNER LLP, 1300 I STREET, NW, WASHINGTON, DC, 20005, US

(73) Assignee: YKK Corporation

(21) Appl. No.: 09/975,933

(22) Filed: Oct. 15, 2001

Related U.S. Application Data
(63) Continuation of application No. 09/595,475, filed on Jun. 16, 2000.

(30) Foreign Application Priority Data
Jun. 17, 1999 (JP) 11-171164

(51) Int. Cl. B32B 15/20

(52) U.S. Cl. 428/674

(57) ABSTRACT

A nickel-free white copper alloy material, wherein a white coating layer containing no Ni is formed on a base material composed of an alloy represented by the general formula: CuₐZn_{b}Mn_{c M}_{d}Xₑ, wherein M is at least one element selected from the group consisting of Al and Sn; X is at least one element selected from the group consisting of Si, Ti and Cr; b, c, d and e are 0≦b≦22, 7≦c≦20, 0≦d≦5 and 0≦e≦0.3 in terms of % by weight; and a is the balance, the alloy incidentally including unavoidable elements. The white copper alloy material has excellent strength and hardness equal to those nickel silver, as well as excellent workability, corrosion resistance and whiteness in addition to ductility, and has no fear of allergic reactions because of containing no Ni. In the white copper alloy material, fine adjustment of its white hue is possible according to the demand of customers, and satisfactory mechanical properties can be obtained with the desired hue.

### BACKGROUND OF THE INVENTION

1. Field of the Invention

The present invention relates to a nickel-free white copper alloy material having excellent strength, hardness, ductility, workability and corrosion resistance, suitable for use, for example, in elements, sliders, stoppers and the like for slide fasteners; ornamental implements such as metallic buttons, fasteners and the like for clothes; or accessories such as pendants or brooches; or eyeglass frames, causing no allergic problem and having high whiteness.

2. Description of the Prior Art

As conventional copper alloys, for example, for the above-mentioned fasteners, copper-nickel-zinc alloys such as nickel silver, which has a white hue, or copper-zinc alloy represented by red brass or brass have been used. Since nickel silver contains nickel as an alloying element, corrosion resistance is excellent. However, for example, where this is applied to the use as a slide fastener, the fastener often contacts with a skin, and there arises the allergic problem due to nickel. Further, since the copper-zinc alloy represented by red brass or brass does not contain nickel, the allergic problem due to nickel does not arise. However, its color tone becomes yellowish, and a white alloy cannot be obtained.

On the other hand, various whitish alloys are proposed. Although those alloys are whitened by slightly modifying alloying components, they have a yellowish or reddish white hue, thereby color tone changes. Further, the customers' demands are various. In some case, a slightly yellowish or reddish white hue is demanded and manufacturers have to respond to such a demand. As a further practical problem, it is desired to provide a nickel-free white material meeting the mechanical properties for use in various applications regardless of slight variations in hue. However, in the case of providing such a material in the form of an alloy as before, there is the problem that it is difficult to provide an alloy satisfying a desired combination with regard to hue and mechanical properties.

### SUMMARY OF THE INVENTION

Accordingly, an object of the present invention is to provide a white copper alloy material having excellent strength and hardness equal to those of nickel silver, as well as excellent workability, corrosion resistance and whiteness in addition to ductility, and having no allergic problem because of containing no nickel, and also provide a white copper alloy material in which fine adjustment of color tone is possible according to the customers' demands and both color tone and mechanical properties are satisfied.

The present invention comprises the following aspects.

(1) A nickel-free white copper alloy material, wherein a white coating layer containing no Ni is formed on a base material composed of an alloy represented by the general formula: CuₐZn_{b}Mn_{c}M_{d}Xₑ, wherein M is at least one element selected from the group consisting of Al and Sn; X is at least one element selected from the group consisting of Si, Ti and Cr; b, c and d are 0≦b≦22, 7≦c≦20, 0≦d≦5 and 0≦e≦0.3 in terms of % by weight; and a is the balance, the alloy incidentally including unavoidable elements.

(2) The nickel-free white copper alloy material as described in (1) above, wherein M is Al and b, c, d and e are 0.5≦b<5, 7≦c≦17 and 0.5≦d≦4 in terms of % by weight.

(3) The nickel-free white copper alloy material as described in (1) or (2) above, wherein the base material and coating layer have such a color tone that a* value and b* value each representing a color tone defined by JIS Z 8729 are −2<a*<5 and −3<b*<16.

(4) The nickel-free white copper alloy material as described in (1) or (2) above, wherein the coating layer has such a color tone that a* value and b* value representing a color tone defined by JIS Z 8729 are −2<a*<3 and −3<b*<15.

### DETAILED DESCRIPTION OF THE PREFERRED EMBODIMENTS

In the alloy composition of the base material of the present invention, Zn has an effect of improving mechanical properties of the alloy through its solid solution strengthening effect and also a cost reduction effect of the alloy. If the Zn content is larger than 22%, season cracking resistance deteriorates and also the crystal structure becomes an α+β phase, so that a sufficient cold-workability cannot be secured. When the Zn content is 5% or more, a solid-solution coexistence temperature range becomes broad, so that macrosegregation tends to be marked and also heat conductivity becomes poor, thereby castability tends to deteriorate. Further, by making the Zn content less than 5%, the problem of the above-mentioned season cracking resistance does not cause at all and also further stable state can be maintained even if element X mentioned hereinafter is added. By making the Zn content 0.5% or more, cost reduction and strengthening effects of the alloy can be expected. From such reasons, the Zn content is more preferably in a range of 0.5% or more to less than 5%. Further, to make the above effects more remarkably, it is particularly preferable that the upper limit is 4%.

Mn has effects in improving the mechanical properties of the alloy by the solid solution strengthening effect and also reducing the cost of the alloy. Further, by addition of Mn in the above-specified amount as a whole or partial replacement of zinc, it exhibits effects in improving the season cracking resistance and preventing the hue of the copper alloy from becoming yellowish excessively. Further, Mn has an effect of lowering the melting point of the alloy and serves to improve the castability and also to suppress vaporization of zinc from a melt. If the content is less than 7%, the color tone becomes yellowish. Conversely, if it is larger than 20%, the crystalline structure becomes an α+β phase, so that a sufficient cold-workability cannot be secured. The upper limit of Mn content is more preferably 15%.

Al and/or Sn have(has) an effect of improving the season cracking resistance by forming a stable oxide film on the alloy surface. Further, it improves the mechanical properties of the alloy by the solid solution strengthening effect and also decreases the cost of the alloy. The amount may be any amount so long as it does not exceed 5%. When the amount is too small, the season cracking resistance and strengthening effect are insufficient. Further, if the amount is larger than 5%, the crystal structure becomes an α+βphase, so that a sufficient cold-workability cannot be secured. 2% or less is more preferred.

Element X (at least one element selected from the group consisting of Si, Ti and Cr) serves to form a coating on a melt surface during melting, and serves to prevent oxidation of Mn and vaporization of Zn. Further, by forming a stable oxide coating on the alloy surface, there occur the functions of preventing elimination of Mn during annealing and improving the season cracking resistance and also the effect in preventing change in color tone with the lapse of time due to oxidation of Mn. The amount may be any amount so long as it does not exceed 0.3%. However, if the amount is too small, the above effects are not sufficiently obtained. Therefore, the amount is preferably 0.02% or more. If the amount is larger than 0.3%, an intermetallic compound is formed with elements in the composition, causing deterioration of cold-workability.

The base material alloy of the present invention is composed of a single α-phase, and can secure a sufficient cold-workability. If outside the composition range defined above, the crystalline structure tends to be an α+βphase, and the workability lowers.

As the alloy systems that can be applied to the base material of the present invention, alloys having the following the general formulae I-V can be applied.

General formula I: Cu_{bal.}Mn₇₋₂₀

General formula II: Cu_{bal.}Mn₇₋₂₀Al_{0.5-5}

General formula III: Cu_{bal.}Mn₇₋₂₀Zn₀₋₂₂ (wherein 0 is not included in the Zn content)

General formula IV: Cu_{bal.}Mn₇₋₂₀Zn₀₋₂₂Al_{0.5-5} (wherein 0 is not included in the Zn content)

General formula V: Cu_{bal.}Mn₇₋₂₀Zn₀₋₂₂Al_{0.5-5}X_{0-0.3}(wherein X is at least one element selected from the group consisting of Si, Ti and Cr; and 0 is not included in the contents of Zn and X)

In the above-mentioned general formulae I-V, particularly useful alloy systems are the following general formulae VI and VII.

General formula VI: Cu_{bal.}Zn_{0.5-5}Mn₇₋₁₇Al₀₋₄X_{0-0.3} (wherein x is at least one element selected from the group consisting of Si, Ti and Cr; the Zn content does not include 5; and the contents of Al and X include 0)

General formula VII: Cu_{bal.}Zn_{0.5-5}Mn₇₋₁₇Al₀₋₄X_{0-0.3} (wherein X is at least one element selected from the group consisting of Si, Ti and Cr; the Zn content includes 5; and the Al and X contents include 0)

Considering mechanical properties, the alloy of the general formula VI is most effective and with respect to the general formulae VI and VII, alloys containing Al in an amount of 0.5% or more is more preferable.

The color tone of the present invention alloy material is in ranges of −2<a*5 and −3<b*<16 based on the chromaticity diagram of the (L* a* b*) colorimetric system when defined by JIS Z 8729.

The color tone mentioned in the present specification is shown by the values of psychometric lightness index L* (brightness: L star), psychometric chromaticity indexes a* (greenish-reddish: a star) and b* (bluish-yellowish: b star) expressed in accordance with the specification of color of materials defined by JIS Z 8729. In particular, in order to be white color that is the characteristic of the present invention, it is better to be a color near achromatic color, which can be defined by the psychometric chromaticity indexes a* and b* as mentioned above.

In the present invention, white near achromatic color is particularly preferred. In this case, it is particularly effective that a color tone of the coating layer is such that a* value and b* value showing a color tone defined by JIS Z 8729 are in ranges of −2<a*<3 and −3<b*<15.

The coating layer of such a color tone is an Sn plating layer, Cr plating layer, Ag plating layer or Cu—Sn plating layer. Any plating layer other than the above-mentioned plating layers is applicable, as long as it shows the above-specified color.

In the case of forming the coating layer by a plating layer, the method may be either a wet plating method or a dry plating method. For example, as a wet plating method, electrolytic plating, electroless plating, melt plating or the like can be applied, whereas as a dry plating method, physical vapor deposition (PVD), chemical vapor deposition (CVD) or the like can be applied.

As a thickness of the coating layer, 0.001-10 μm is an effective range. In the case of less than 0.001 μm, the effect for covering the base material cannot be expected, and also, for example, in the case of using as elements of a slide fastener, there is the possibility of abrasion by sliding of a slider. The upper limit of thickness is not particularly set. However, a coating thickness exceeding 10 μm is too large and not so effective, when considering the production cost.

Further, in the case of applying a post-working such as cutting or bending, the thickness of the coating layer is preferably in a range of 0.005-5 μm, when considering the possibilities of abrasion, crack or the like due to such a post-working. In the case of less than 0.005 μm, the coating layer tends to mechanically peel or abrade during the post-working such as cutting or bending. On the other hand, in the case of exceeding 5 μm, crack or the like tends to occur during the above-mentioned post-working. In the coating layer that is not subjected to such a post-working, the thickness is preferably in a range of 0.001-10 μm from the above-mentioned economic viewpoint. For example, in the preparation of elements of a slide fastener, a wire having a cross section of Y-shape is prepared and cut into a predetermined size. The cut pieces are caulked and affixed to one side edge of a slide fastener tape to prepare a chain for a slide fastener. In the case where forming the coating layer on the wire having a cross section of Y-shape is followed by the above post-working such as cutting or bending, the coating is formed in a thickness range of 0.005-5 μm, considering such a post-working. However, in the case where the coating layer is formed on the element part of a chain for a slide fastener without requiring the subsequent steps, it may be formed in a range of 0.001-10 μm.

The present invention is explained specifically below based on the examples.

(Base Materials of the Present Invention)

With respect to the base materials 1-14 of the present invention shown in Table 1 and base materials 1-9 of the present invention shown in Table 2, test materials were prepared and evaluated as described below.

TABLE 1

| | | | | | | | | | | | | | | | Existence of | | |
|---|---|---|---|---|---|---|---|---|---|---|---|---|---|---|---|---|---|
| | | | | | | | | | | Color tone | | | | Hard- | crack after | | Season |
| | | Alloy composition (wt %) | | | | | | | | Color | | | | ness | 80% | Discoloration | cracking |
| | | Cu | Zn | Mn | Al | Ti | Si | Cr | Ni | tone | a* | b* | Structure | (Hv) | deformation | resistance | resistance |
| Base | 1 | Balance | 2.5 | 14 | 1 | — | | | — | White | 3.09 | 9.66 | α | 110 | ◯ | 6.09 | ◯ |
| material | 2 | Balance | 3 | 15 | 2 | — | — | — | — | White | 3.12 | 9.78 | α | 113 | ◯ | 6.48 | ◯ |
| | 3 | Balance | 2 | 10 | 1 | — | — | — | — | White | 4.52 | 10.27 | α | 105 | ◯ | 6.15 | ◯ |
| | 4 | Balance | 4 | 15 | 1 | — | — | — | — | White | 3.01 | 7.75 | α | 114 | ◯ | 6.24 | ◯ |
| | 5 | Balance | 4 | 7 | 1 | — | — | — | — | White | 3.08 | 9.63 | α | 113 | ◯ | 6.12 | ◯ |
| | 6 | Balance | 4 | 15 | 0.5 | — | — | — | — | White | 2.86 | 9.41 | α | 113 | ◯ | 6.23 | ◯ |
| | 7 | Balance | 1 | 14 | 1.5 | — | — | — | — | White | 3.03 | 9.73 | α | 111 | ◯ | 6.93 | ◯ |
| | 8 | Balance | 2.5 | 14 | 1 | 0.05 | — | — | — | White | 2.89 | 9.09 | α | 101 | ◯ | 6.73 | ◯ |
| | 9 | Balance | 2.5 | 14 | 1 | — | 0.05 | — | — | White | 3.00 | 9.87 | α | 102 | ◯ | 5.17 | ◯ |
| | 10 | Balance | 3 | 14 | 1 | — | — | 0.02 | — | White | 3.03 | 9.66 | α | 101 | ◯ | 5.49 | ◯ |
| | 11 | Balance | 2.5 | 13 | 1 | — | 0.1 | — | — | White | 3.62 | 7.07 | α | 131 | ◯ | 7.15 | ◯ |
| | 12 | Balance | 2 | 14 | 1 | — | 0.3 | — | — | White | 3.29 | 9.40 | α | 154 | ◯ | 7.52 | ◯ |
| | 13 | Balance | 2.5 | 12 | 1 | — | 0.05 | 0.02 | — | White | 3.53 | 8.18 | α | 130 | ◯ | 8.53 | ◯ |
| | 14 | Balance | 2.5 | 14 | 1 | 0.05 | 0.05 | — | — | White | 3.30 | 8.33 | α | 172 | ◯ | 5.86 | ◯ |

TABLE 2

| | | | | | | | | | | | | | | | Existence of | | |
|---|---|---|---|---|---|---|---|---|---|---|---|---|---|---|---|---|---|
| | | | | | | | | | | Color tone | | | | Hard- | crack after | | Season |
| | | Alloy composition (wt %) | | | | | | | | Color | | | | ness | 80% | Discoloration | cracking |
| | | Cu | Zn | Mn | Al | Ti | Si | Cr | Ni | tone | a* | b* | Structure | (Hv) | deformation | resistance | resistance |
| Base | 1 | Balance | 9 | 14 | 1 | 0.3 | — | — | — | White | 2.38 | 7.54 | α | 136 | ◯ | 5.67 | ◯ |
| material | 2 | Balance | 9 | 14 | 1 | — | 0.3 | — | — | White | 2.44 | 8.19 | α | 129 | ◯ | 6.43 | ◯ |
| | 3 | Balance | 10 | 15 | 1 | — | — | 0.02 | — | White | 2.40 | 7.68 | α | 123 | ◯ | 5.94 | ◯ |
| | 4 | Balance | 17 | 13 | 0.5 | 0.1 | — | — | — | White | 1.65 | 7.51 | α | 115 | ◯ | 6.23 | ◯ |
| | 5 | Balance | 14 | 10 | 1 | | 0.1 | 0.02 | — | White | 0.46 | 14.23 | α | 142 | ◯ | 5.34 | ◯ |
| | 6 | Balance | 17 | 8 | 1 | 0.3 | — | — | — | White | 0.25 | 12.98 | α | 129 | ◯ | 5.67 | ◯ |
| | 7 | Balance | 18 | 10 | 2 | — | 0.2 | — | — | White | 0.32 | 10.41 | α | 126 | ◯ | 6.65 | ◯ |
| | 8 | Balance | 20 | 8 | 1 | — | 0.05 | 0.02 | — | White | 0.04 | 12.68 | α | 143 | ◯ | 5.23 | ◯ |
| | 9 | Balance | 18 | 10 | 2 | 0.05 | 0.05 | — | — | White | 0.38 | 10.35 | α | 138 | ◯ | 5.72 | ◯ |

Pure Cu (99.9%), pure Zn (99.9-99.99%), pure Mn (99.9%), pure Al (99.99%), pure Ti, pure Si and pure Cr were measured for making up an ingot of 200 cm³ for each predetermined composition. Each composition was melted with high frequency in an Ar atmosphere (10 cmHg), maintained for 4 minutes and then poured into a copper casting mold (40 mm in diameter×28 mm in length). The ingot of 200 cm³ thus obtained was cut in a length of about 70 mm to form a billet for extrusion. Extrusion was conducted at a billet temperature of 800° C. and a container temperature of 600° C. A heat treatment at 800° C. for 1 hour followed by cooling in a furnace (the sequence is hereinafter referred to as “a heat treatment”) was applied to the extruded material obtained (8 mm in diameter×about 1300 mm in length). The extruded material (wire) to which this heat treatment was applied was used as a base material for test.

The test materials obtained were subjected to mirror polishing with a SiC polishing paper and a diamond paste, and measured using a chromatic color-difference meter (CR-300, manufactured by Minolta Ltd.), and the results were expressed by L*, a* and b* as defined in JIS Z 8729.

All the test materials (base materials) of the present invention have a white color tone, and where they are used as a fastener part, a part having a high-grade feeling can be provided. Particularly, it can be seen that the materials shown in Table 2 had a* values of 3 or less and thus showed a white hue closer to an achromatic color.

Further, each of the thus obtained test materials (base materials) was observed for microcrystalline structure. The inventive test materials (base materials) were all composed of a single α-phase and had a good cold-workability. Where a secondary phase is present, cracks or the like occurred during cold-working. However, in the base materials of the present invention, occurrence of crack or the like was not observed. In particular, in the case of use as elements of a fastener, Y-shaped elements are caulked and affixed to a cloth. The fastener elements made of the inventive material can be firmly affixed to a cloth without cracking, etc.

Hardness (Hv) is shown by values DPN by a Vickers microhardness tester with a load of 25 g. It is understood that the materials of the inventive examples have hardness equal to that of nickel silver currently used as a part for a fastener, and are provided with superior mechanical properties such as high strength and high hardness, suitable as a fastener part.

Further, 80% strain was given to the test materials (base materials) obtained, by a cold compression test, and the presence or absence of crack on the surface was observed.

In Tables 1 and 2, “O” shows that crack was not present on the surface of the base material. It is understood that in all the materials of the inventive examples, crack was not present on the surface. As mentioned above, in the use as elements of a fastener, 80% strain at the maximum is given in the cold when affixing them to a cloth. From the above results, it is understood that the base materials of the inventive examples have no problem even if 80% strain is given in the cold.

Discoloration resistance was examined in such a manner that the test materials (base materials) obtained were subjected to mirror polishing with a SiC polishing paper and a diamond paste and a constant temperature and humidity test was conducted by exposing the materials to an atmosphere at 80° C. and 90% RH. The surfaces of the test materials (base materials) thereafter were measured using the colorimetric color-difference meter. Evaluation of the discoloration resistance was conducted based on numerical values obtained by introducing indexes before and after the constant temperature and humidity test into the following equation.

Discoloration=\sqrt{(a*)²+(b*)²+(L*)²}−{square root over (((a′*)²+(b′*)²+(L′*)²)}

(In the formula, a*, b* and L* are indexes before the constant temperature and humidity test, and a′*, b′* and L′* are indexes after the constant temperature and humidity test.)

It is clear from the test results shown in Tables 1 and 2 that the materials of the inventive examples give small values in the above-mentioned equation and have excellent discoloration resistance. From this fact, it is clear that when using the inventive materials as a fastener part, the fastener part exhibits high discoloration resistance to washing with warm water. In this test, washing with warm water in Europe is conducted as a standard.

A season cracking resistance was evaluated such that 80% strain was given to the test material obtained, by a cold compression test, the material was exposed to ammonia using a 12.5% aqueous ammonia solution, and occurrence of crack on the surface was observed. In Tables 1 and 2, O shows that crack did not occurred on the material surface, and it is understood that in all of the base materials of the present invention, crack did not occur on the surface. From this fact, it is understood the present invention can provide a material that is unsusceptible to the problem of crack or the like due to strain applied, atmosphere or environment even though caulked and affixed as elements of a slide fastener to a cloth. In the Tables, although good season cracking resistance is shown in Tables 1 and 2, the materials shown in Table 1 have especially superior results as compared with the materials shown in Table 2.

As the extruded materials (wire) thus obtained, there are provided, for example, a round wire having a cross section shape of a circle, a straight angle wire having a cross section of a rectangle and an irregular wire having a cross section of an irregular shape. Further, there is an irregular wire obtained through multistage rolling of the above-mentioned round wire or straight angle wire to gradually change its cross section shape, thereby making the cross section shape irregular. Such a wire can directly (without forming a coating layer) be used for the preparation of elements, sliders and stoppers of fasteners, buttons, stoppers for clothes; accessories such as eyeglass frames, rings or pierces; pen point of ball point pens or the like which may contact with a human body. In the present invention, further considering appearance design and mechanical properties, a coating layer was formed on the base materials as described below.

### EXAMPLE 1

A wire having a Y-shaped cross section, composed of Cu_{bal.}Zn₃Mn₁₃Al₁Si_{0.05} (wt %) was prepared in the same manner as in the above-mentioned preparation method of the base material. Sn plating was applied to the wire by electroless plating in an acidic bath having an Sn concentration of 14-24 g/l at a temperature of 48-52° C. in an acidic bath to form a coating layer.

### EXAMPLE 2

An Sn plating coating layer was formed on the wire of Example 1 by an electroless plating in an acidic bath under conditions of Sn concentration 30-80 g/l, temperature 15-50° C. and current density 2-100 A/dm².

### EXAMPLE 3

A wire having a Y-shaped cross section, composed of Cu_{bal.}Zn₁₆Mn₁₃Al₁ (wt %) was prepared in the same manner as in Example 1. An Ag plating coating layer was formed on the wire by electroless plating under conditions of Ag concentration 0.8-40 g/l, temperature 20-30° C. and current density 0.5-4 A/dm².

### EXAMPLE 4

A wire having a Y-shaped cross section, composed of Cu_{bal.}Zn₁Mn₁₀Al₁Si_{0.03}(wt %) was prepared in the same manner as in Example 1. A Cu—Sn plating coating layer was formed on the wire by electroless plating under conditions of Cu concentration 10.5 g/l, Sn concentration 35.0 g/l, temperature 60° C. and current density 0.5 A/dm².

With respect to Examples 1-4, each wire having a coating layer formed thereon was cut into every predetermined size. The cut pieces were caulked and affixed to the side edge portion of a tape for a slide fastener as elements to prepare a chain for a slide fastener. The thus obtained chain for a slide fastener was evaluated as described below.

### EXAMPLE 5

A wire having Y-shaped cross section, composed of Cu_{bal.}Zn₁₇Mn₁₄Al₁ (wt %) was prepared in the same manner as in the above-mentioned preparation method of the base material. This was cut into every predetermined size and the cut pieces were caulked and affixed to the side edge portion of a tape for a slide fastener as elements to prepare a chain for a slide fastener. An Sn plating coating layer was then formed under the same conditions as in Example 1.

### EXAMPLE 6

An Sn plating coating layer was formed on the chain for a slide fastener of Example 5 under the same conditions as in Example 2.

### EXAMPLE 7

A wire having a Y-shaped cross section, composed of Cu_{bal.}Zn₂Mn₁₂Al₁Si_{0.05} (wt %) was prepared in the same manner as in the above-mentioned preparation method of the base material. This was used to form a chain for a slide fastener in the same manner as in Example 5, and an Ag plating coating layer was formed under the same conditions as in Example 3.

### EXAMPLE 8

A wire having a Y-shaped cross section, composed of Cu_{bal.}Zn₃Mn₁₃Al₁Si_{0.05} (wt %) was prepared in the same manner as in the above-mentioned preparation method of the base material. This was used to form a chain for a slide fastener in the same manner as in Example 5, and a Cu—Sn plating coating layer was formed under the same conditions as in Example 4.

### Comparative Example 1

A wire having a Y-shaped cross section, composed of Cu_{bal.}Zn₁₅ (wt %) was prepared in the same manner as in the above-mentioned preparation method of the base material. This was used to form a chain for a slide fastener in the same manner as in Example 5, and an Sn plating coating layer was formed under the same conditions as in Example 1.

### Comparative Example 2

An Sn plating coating layer was formed on the chain for a slide fastener of comparative Example 1 under the same conditions as in Example 2.

### Comparative Example 3

A wire having a Y-shaped cross section, composed of Cu_{bal.}Zn₃₀ (wt %) was prepared in the same manner as in the above-mentioned preparation method of the base material. This was used to form a chain for a slide fastener in the same manner as in Example 5, and an Ag plating coating layer was formed under the same conditions as in Example 3.

### Comparative Example 4

A wire having a Y-shaped cross section was prepared from a nickel silver composed of Cu_{bal.}Zn₂₄Ni₁₃ (wt %) in the same manner as in the above-mentioned preparation method of the base material. This was used to form a chain for a slide fastener in the same manner as in Example 5, and a Cu—Sn plating coating layer was formed under the same conditions as in Example 4.

Corrosion resistance test, decorative test and Ni allergy test were conducted with respect to the thus obtained chains for a slide fastener of Examples 1-8 and Comparative Examples 1-4.

The corrosion resistance test was conducted in such a manner that each wire was exposed to an atmosphere at 80° C., 90% RH atmosphere for 2 hours. A constant temperature and humidity test was conducted, and color change (discoloration) of the element surface after the test was visually observed. In the evaluation, the elements in which color change due to the test was visually observed were marked “X”, and the element in which discoloration was not observed was marked “O”. The decorative test was conducted in such a manner that a slider for a slide fastener was mounted to a pair of the chains for a slide fastener obtained, and the chains were examined for durability to reciprocating opening and closing of 3000 times and visually observed as to whether the base materials were exposed from the coating layer or not. The evaluation was that the sample in which the base material surface was visually exposed after the test was marked “X”, and the sample in which the surface was not exposed was marked “O”.

An Ni allergy test was conducted in such a manner that a slider for a slide fastener was mounted to a pair of the chains for a slide fastener obtained, durability to reciprocating opening and closing of 3000 times was conducted to the chains to evaluate them based on European Standard EN1811. In the evaluation, samples which failed to satisfy the requirements of European Standard EN1811 were marked “X”, and the samples which could satisfy the same requirements were marked “O”.

Those results are shown in Table 3. From the results in Table 3, it is understood that the alloy materials (elements of a slide fastener chain) of the present invention are excellent in corrosion resistance, and decorative property and are free from the fear of Ni allergy. Further, the above chain for a slide fastener was sewed on clothes, and various washing tests were conducted. As a result, those in which the alloy materials of the present invention were used showed good results in the above-mentioned corrosion resistance and decorative property.

TABLE 3

| | Corrosion | Decorative | |
|---|---|---|---|
| | resistance | property | Ni allergy |
| Example 1 | ◯ | ◯ | ◯ |
| Example 2 | ◯ | ◯ | ◯ |
| Example 3 | ◯ | ◯ | ◯ |
| Example 4 | ◯ | ◯ | ◯ |
| Example 5 | ◯ | ◯ | ◯ |
| Example 6 | ◯ | ◯ | ◯ |
| Example 7 | ◯ | ◯ | ◯ |
| Example 8 | ◯ | ◯ | ◯ |
| Comparative | ◯ | X | ◯ |
| Example 1 | | | |
| Comparative | ◯ | X | ◯ |
| Example 2 | | | |
| Comparative | ◯ | X | ◯ |
| Example 3 | | | |
| Comparative | ◯ | ◯ | X |
| Example 4 | | | |

Further, each of the above chains for slide fasteners was evaluated for the items defined in JIS S 3015: for example, chain crosswise pulling strength, bendability, crosswise pulling and pushing, element smoothness and drawing, sliding resistance, slider lock, reciprocating open and close endurance (grade M), etc. As a result, the fastener chains of the inventive examples showed good properties equivalent to those of nickel silver heretofore used.

The present invention provides a nickel-free white copper alloy material, in which the base material has excellent strength and hardness equal to those of nickel silver, as well as excellent workability and corrosion resistance in addition to ductility. Since a white or whitish coating layer is formed on the base material, materials having various color tones can be provided due to this coating layer, as demanded by customers. Also, since the base material is per se white, even if the base material is not entirely coated with the coating layer or even if the coating layer is subjected to peeling, cracking or the like which results in exposure of the base material, the external appearance of the inventive alloy material is not greatly impaired. Further, since the base material and the coating layer are Ni-free, the alloy material provided by the present invention has no fear of allergic reactions even if it is used, for example, in elements, sliders, stoppers or the like for fasteners, accessories such as buttons, stoppers of clothes, eyeglass frames, rings, necklaces or pierces or the like which may contact with a human body and thereby come into contact with skin.

What is claimed is:

1. A nickel-free white copper alloy material, wherein a white coating layer containing no Ni is formed on a base material composed of an alloy represented by the general formula: CuₐZn_{b}Mn_{c}M_{d}Xₑ, wherein M is at least one element selected from the group consisting of Al and Sn; X is at least one element selected from the group consisting of Si, Ti and Cr; b, c, d and e are 0≦b≦22, 7≦c≦20, 0≦d≦5 and 0≦e≦0.3 in terms of % by weight; and a is the balance, said alloy incidentally including unavoidable elements.

2. The nickel-free white copper alloy material according to claim 1, wherein M is Al and b, c and d are 0.5≦b<5, 7≦c≦17 and 0.5≦d≦4 in terms of % by weight.

3. The nickel-free white copper alloy material according to claim 1, wherein said base material and coating layer have such a color tone that a* value and b* value representing a color tone defined by JIS Z 8729 are −2<a*<5 and −3<b*<16.

4. The nickel-free white copper alloy material according to claim 1, wherein said coating layer has such a color tone that a* value and b* value representing a color tone defined by JIS Z 8729 are −2<a*<3 and −3<b*<15.
